(19) United States
(12) Patent Application Publication
(10) Pub. No.: US 2007/0171091 A1
(43) Pub. Date: Jul. 26, 2007

(54) Environmental control system

(76) Inventors: Gregory Nisenboim, Arad (IL); Evgeny Nisenboim, Arad (IL)

Correspondence Address: Kevin D McCarthy;Roach Brown McCarthy & Gruber, 1620 Liberty Building, Buffalo, NY, 14202, US

(21) Appl. No.: 10/589,456

(22) PCT Filed: Feb. 15, 2005
(86) PCT No.: PCT/IL05/00191

§ 371 Date: Jan. 8, 2007

(30) Foreign Application Priority Data
Feb. 16, 2004 (IL) 160429

(51) Int. Cl. G08C 19/00

(52) U.S. Cl. 340/825.69; 341/176; 340/825.49; 340/3.71

(57) ABSTRACT

System for allowing a user, by use of a remote controller, to control the operation of appliances located in different sub-environments of an environment, that comprises a plurality of sub-environments' recognition means, each one is allocated to a respective sub-environment and equipped with a code unique to the respective sub-environment; and a remote controller, configured to obtain from the recognition means location signal that contains the unique code to recognize the sub-environment the controller is currently in. The controller introduces to the user, in response to the recognition of a sub-environment, control options relevant only to appliances that are located in the recognized sub-environment. The controller includes user interaction means to allow the user to activate the control options, as desired by him.

### FIELD OF THE INVENTION

This invention relates to the field of remote controllers of electrical appliances, equipments and communication means, generally known collectively as Environmental Control Systems (ECS). More particularly, the present invention relates to a portable remote controller for controlling the operation of a large number of appliances in a most convenient manner.

### BACKGROUND OF THE INVENTION

As more and more electrical appliances are added to living and/or working environments, and to other environments, such as a warehouse, a car, backyards, and so forth, it becomes increasingly desirable, and sometimes necessary, to remotely control and program said appliances.

Remote control systems are known for operating appliances, equipment and different types of electrical devices and apparatuses, such as TV, VCR, etc., but they can also operate other devices and applications, such as phones, Internet applications, etc. (hereinafter referred to collectively as “appliances”) in various kinds of environments (e.g., an apartment). Some of them involve use of a handheld remote controller, to render the operation of the appliances easy and convenient. Usually, handheld remote controllers display to their users menus that include a plurality of items. Said items are generally in the form of icons, for making the selection of a desired option intuitive. By ‘intuitive’ is meant that a user can select a desired control option after taking a relatively short glance at the icons displayed to him by the controller. In addition, efforts are made to minimize the size of hand held remote controllers, for allowing their users to grip the controllers, and operate the appliances controlled by them, using only one hand.

Many of the conventional hand held remote controllers can control only a limited number of appliances because of the small size of their displays, as well as for other reasons. The smaller the size of a display, the smaller is the number of the items, or icons that can be simultaneously displayed on it. Moreover, in some cases it is difficult for the operator of such remote controllers to aim a finger to perform a ‘press action’ on preferred icon/button of a small size. For this reason, menus are formed, which include a multiplicity of icons, and each menu is browsed by a user of the remote controller, until the icon(s) of the desired appliance(s), and the depressible buttons required for its control, are displayed to the user. Commonly, the user has to browse through one or more irrelevant menus before finding the desired appliance, which is very inconvenient particularly if the number of the appliances, and therefore the number of menus, is large. In such cases, a long time may lapse before the user finally reaches the preferred option, which may be problematic, and sometimes crucial, in cases of emergency situations, for example, when an ambulance service is sought by use of the capability of the remote controller to operate as a telephone device. In addition, in such cases the number times, which the user of the controller has to press on icons, is large, which is a problem if the user of the controller is a person that has a physical problem that does not allow the user to operate the controller in ‘normal’ manner.

Because of the above drawbacks, some hand held remote controllers are limited to control a small number of appliances, e.g. located in a single room, while other systems, designed to control a large number of appliances in a relatively extended area, are complicated, difficult to operate and learn, and, in addition, they are costly to install.

Usually, a user of a handheld remote controller would prefer operating only those appliances which are located in his vicinity. Put otherwise, having an environment, for example, a house, divided into several sub-environments (e.g., different rooms in the house), it is common that whenever the operator, or user, of the handheld remote controller enters, say, a first sub-environment in the environment (i.e., he enters a first room in his house), he would probably want to operate only those appliances that are located in that particular room, but not appliances residing in other rooms. Likewise, should the user of the controller enters a second room, he might usually want to operate only those appliances that are located in the second room, but not any of the appliances located in the first room, or in other rooms for that matter.

Pursuant to the above-described notion, there is no point in scrolling, or browsing, through menus which relate to non-relevant appliances (i.e., appliances not located at the room where the user is currently in), as occurs with conventional handheld remote controllers, but, rather, it is preferable that only a menu (hereinafter ‘relevant menu’) relating to appliances located in the same sub-environment as the remote controller be displayed to the user of the remote controller. Offering only relevant menus to a user is beneficial for two main reasons: (1) it allows exploiting the display of the remote controller more effectively, (2) it make its operation by a user much easier and more convenient, comparing to conventional remote controllers, in which case a user has to brows through irrelevant menus, and, in particular, displaying only relevant menus to a user will significantly decrease the number of interactions between the user and the related remote controller, by which ‘interaction’ is meant pressing, by the user, on particular button, or icon, displayed to him by the remote controller, and displaying to the user, by the remote controller, a corresponding menu, or icon(s) in response to the pressing, and (3) displaying only relevant menus will save time in accessing desired appliance and operating the desired appliance.

The known remote controllers of electrical appliances are generally intended for use by healthy people, and therefore, are ill-equipped for satisfying the needs of elderly and handicapped, and disabled persons. For example, an elderly or physically challenged person may not be capable of depressing buttons, or icons, to select/operate an appliance, or may not be able to see, or at least to see clearly, the iconic representation of appliances and/or the control options.

EP1102500 discloses a wireless mobile unit according to which as position information of a wireless mobile unit is received, it is compared to stored position information of a remote location, such as a home. As the traveler approaches his home, and gets within a certain distance from home, a signal is transmitted to a controller residing in his home, to perform an action or to instruct the performance of an action.

U.S. Pat. No. 5,109,222 discloses a remote-control system that comprises a computer for controlling appliances located in a plurality of rooms in a building. The computer is located in one of the rooms of the building and is wired to sensors in rooms of the building in which appliances controlled by the system are located.

U.S. Pat. No. 5,554,979 discloses a “point and operate” system for controlling appliances in a localized space or a room of a building. Each appliance controlled by the system is connected to its own control unit that has a receiver for receiving signals from a hand held controller. The hand-held controller comprises a directional emitter, such that a narrow beam IR is transmitted. Controlling any appliance is carried out by the user by pointing the controller at the receiver connected to the controlled appliance, and pressing proper buttons on the handheld controller.

WO 00/58925 discloses a remote-control system for controlling a plurality of devices located in different rooms of a structure. According to WO 00/58925, the user may use a controller to operate from his room devices located in other rooms, by causing wireless control signals to be transmitted from one side of the wall to the other side of that wall.

U.S. Pat. No. 5,016,003 discloses a method for providing a handicapped user with control over his environment, which comprises
(a) presenting, one at the time, in a predetermined sequence, a first set of options to said user;
(b) selecting one of said options within said set in response to user manipulation of a control having first and second active positions in synchronism with the time said one option is presented to said user;
(c) presenting one at the time, in sequence, a further set of options different from said first set of options to said user in response to said selective step (b);
(d) subsequent to said step (b), repeating said presenting step (a) in response to further said user manipulation of said same control to said first active position;
(e) selecting one of said options within said further options set in response to further user manipulation of said same control to said second active positioning synchronism with the time said one of said further options is presented to said user; and
(f) controlling the operation of an appliance in response to said selecting step (e).

However, U.S. Pat. No. 5,016,003 has the drawbacks that the menus are not selected automatically according to the actual location of the controller, and, secondly, a user has to wait a considerable amount of time before the desired options are displayed to him.

U.S. Pat. No. 5,345,226 discloses a similar environmental control method. Both the aforesaid methods comprise a user interface that is relatively complex and not as easy to learn as would be desirable and further require complex and expensive apparatus.

U.S. Pat. No. 5,600,311 discloses a method for the same purpose which comprises electrically detecting user-actuated switch closures; selecting between a first and a second operating modes; in the first operating modes selecting manual options in response to a detected switch closures; in the second operating mode generating further output switch closures; controlling other equipment with said further output switch closures; and remaining in said second operating mode until a predetermined event occurs. This method too requires a relatively complex user interface and is neither simple nor quick to operate. Further, the apparatus it requires is relatively complex.

It is seen therefore that none of the remote control systems and Environment Control Systems (ECSs) known in the art is fully satisfactory for operation by physically challenged, or elderly, persons.

It is also seen that none of the remote control systems and Environment Control Systems (ECSs) known in the art is fully satisfactory in terms of irrelevant menus being displayed to the user of these systems.

It is therefore a purpose of this invention to provide a remote control system, particularly, though not exclusively, intended for use by physically and/or mentally challenged persons, which is operable by the user immediately, with the outmost ease, and that will improve the life quality of the controller's users.

It is another purpose of this invention to provide such a system which is simple and inexpensive.

It is a further purpose of this invention to provide a portable remote controller which contains all the components of the system, except for some locally installed environment recognition means and proximity sensors, for indicating the relevant sub-environments and for indicating to the controller the proximity of relevant appliances to the controller, respectively.

It is a still further purpose of this invention to provide a method for the remote control of appliances which is immediately understood and can be carried out without need of particular instructions, being evident and immediately understood by any user.

It is a still further purpose of this invention to provide a method and a system for the remote control of appliances which can be used by persons having severe limitations of sight or hearing.

It is a still further purpose of this invention to provide a method and a system that constantly learns the user's behavior, analyze its behavior and automatically offer to him the most probable task(s) in accordance with time frames, user location, or a correlation therebetween.

It is a still further purpose of this invention to provide a method and a system which incorporate innovative Graphical User Interface (GUI) that conforms to the way of thinking and dynamically adapts itself to its user and thus offers help to a physically and/or mentally challenged user.

It is yet another purpose of this invention to provide a remote controller for controlling appliances, which is capable of making and receiving phone calls and communicating with cellular networks and with the Internet.

Other purposes and advantages of the invention will appear as the description proceeds.

### SUMMARY OF THE INVENTION

The present invention provides a system and method for allowing a user to control the operation of appliances in an environment, which are distributed among sub-environments, based on the sub-environment in which the user is currently in.

By ‘location recognition (process)’ is meant hereinafter that the remote controller (herein after just ‘controller’) of this invention receives, from a respective device (hereinafter ‘sub-environment recognition means’) a signal (hereinafter ‘location signal’) indicative of the sub-environment which the controller is currently in. The controller, thus, becomes ‘aware’ of its current location (i.e., sub-environment) in the environment. The location recognition phase is effected by causing, e.g., a beacon to emit a location signal to the controller in response to an inquiry signal that is emitted from the controller, or in response to sensed heat that is irradiated from the body of the user that is assumed to carry the controller, while the controller is in the same sub-environment as the beacon device. Optionally, the location signal can be emitted from the sub-environment recognition means independently of an inquiry signal. Alternatively, the location recognition phase can be effected by causing, e.g., an electronic Tag to emit the location signal to a Tag reader cooperating with the controller, in response to an inquiry signal that is emitted from the reader, which is caused to do so by the controller.

By ‘appliance identification’ is meant hereinafter a process where a unique digital code (hereinafter just ‘code’, or, sometimes, ‘unique code’), which is allocated to a specific appliance, is caused to be forwarded to the controller, to allow the identification of the specific appliance by the controller. The identification of an appliance is intended to occur only if the controller is close enough to the appliance that is to be identified by it. The digital code can either be stored in the appliance and be transmitted by it whenever require, or it can be stored in an electronic Tag (sometimes just ‘Tag’) that is externally attached to, or is nearby, the specific appliance. Both beacons and Tags can be utilized, mutatis mutandis, for recognizing sub-environments and for identifying appliances.

By ‘menu’ is meant hereinafter an introduction, or announcing, by the controller of the invention to its user and in queue manner, of sub-environments, their related appliances and their control options. By ‘relevant menu’ is meant hereinafter an introduction, or annunciation, by the controller of the invention to its user, of a specific, currently recognized, sub-environment in an outstanding manner, with respect to the other sub-environments, along with its related appliances and their control options, possibly in a queue manner.

The system for allowing a user, by use of a remote controller, to control the operation of appliances located in different sub-environments of an environment (the control being based on the location, i.e., sub-environment of the appliances) comprises:
a) a plurality of sub-environments' recognition means, each of which is allocated to a respective sub-environment and equipped with a code unique to the respective sub-environment, and configured to wirelessly forward to the controller a location signal that includes the unique code whenever the presence of the controller, or the user, is detected by the corresponding recognition means; and
b) a remote controller, provided with means and configured to cause the recognition means to communicate to it location signals to recognize thereby a sub-environment the controller is currently in, whereby to introduce to the user a menu relevant only to appliances that are located in the recognized sub-environment. The controller includes user interaction means to allow the user to control the appliances.

According to a preferred embodiment of the invention, appliance's identification means are allocated to one or more desired appliances in the controlled environment, and the controller is provided with means for communicating with the appliance's identification means, for allowing the identification of the appliances by the controller whenever the controller is currently in the vicinity of one of one of these appliances. Such communication means may include wireless means, e.g., Bluetooth or Wi-Fi transceivers. As described hereinbefore, the appliance's identification means can be, e.g., an electronic Tag or a beacon. The Tag includes a unique transmittable code, and a reader with which the Tag communicates. The reader transmits an inquiry, or excitation, signal to the Tag, causing thereby the Tag to transmit its unique code to the reader, which forwards the unique code further to the controller to allow it to identify the appliance in which vicinity it is located.

Each electronic Tag can be embedded into, affiliated into, combined with, or incorporated into the corresponding appliance, such that each Tag has a unique code, to make them distinctable to the controller. The reader can be a ‘stand-alone’ device that is adjoined to the controller, or it can be affiliated into, combined with, or incorporated into the controller. The reader can communicate with the controller wirelessly, but this is not necessarily so, such as when the reader is incorporated into the controller.

According to one embodiment of the present invention, the system further comprises “IR-to-RF” and “RF-to-IR” converters, for allowing the controller to control IR-driven appliances that are not necessarily in the same sub-environment as the controller. According to this embodiment, the controller can forward operation commands to, e.g., an appliance located in a different room by emitting IR signals to an “IR-to-RF” that converts the IR signal into an RF signal. Then, the RF signal is received by a corresponding “RF-to-IR” converter (which can be located essentially in any other sub-environment) which converts the RF signal back into the original IR signal, which is then received at the relevant controlled appliance. An exemplary converter is the Remote-control extender, which is manufactured by Terk Technologies Corporation, Commack, N.Y., U.S.A. No line of sight is needed to use such converter. Therefore, there is no need to point toward the device with the controller, in order to operate it. Alternatively, converters that involve Blue-Tooth and/or Wireless Fidelity (Wi-Fi is a term for certain types of wireless local area network (WLAN) that use specifications in the 802.11 family).

The controller preferably comprises:
a) communication means, as required for communication with the recognition and identification means for recognizing sub-environments and for identifying appliances, respectively;
b) control means, including a processor, a memory and software for operating said processor;
c) an optical or acoustic, or both optical and acoustic, means for introducing to the user sub-environments, appliances and control options, and, in particular, appliances and their control options which relate to recognized sub-environments;
d) means for said user to choose a particular sub-environment or a particular appliance, or appliances, that he wishes to control; and
e) means for controlling the chosen appliance or appliances.

According to one preferred embodiment of the present invention, the functions performed by the means described in a) to e) above, are incorporated, or affiliated, into a PDA or into a Tablet PC.

The optical means is preferably a screen, or a touch screen, which is functionally divided into at least three sections. The first section introduces to the user icons, or symbols, that represent, or relate, to the sub-environments, such that the icon/symbol relating to a recognized sub-environment is made by the controller outstanding, with respect to the other icons/symbols. The second section introduces to the user the appliances belonging to a currently recognized sub-environment, and the third section introduces to the user the control options relating to a chosen appliance (i.e., chosen by the user), or to an identified appliances (i.e., identified by using electronic Tag and a reader).

Accordingly, according to a preferred embodiment of the invention, the controller further comprises bidirectional wireless telephone interface, such as GSM/GPRS communication means, for imparting it capabilities of a cellular telephone, including the capability of communicating with the Internet infrastructure.

According to the invention, the controller is user-configurable, which means that the user can: (1) preset the controller with available appliances and sub-environments, and to relate each one of the appliances to a corresponding sub-environment, (2) relate voice files to one or more of the icons that represent appliances and/or sub-environments and/or control options for controlling the appliances. The voice files can be, e.g., recorded by the user by using his own voice, or another person's voice, or be created using text-to-voice software tools, and they allow the controller to announce to the user current sub-environments, control options and status of the controller, (3) program user defined macros, which relate to one or more sets of tasks. Each of the user defined macros is intended to be executed by the user using a single interaction with the controller, to perform the set of tasks related to the executed macro. For example, one set of tasks can include turning on a TV set in a specific room, while at the same time, dimming the light in the same room. This exemplary set of tasks will be executed by the controller using only a single interaction between the user and the controller, such as by tapping on the touch screen of the controller, or by issuing by the user a single oral command that will cause the controller to perform this set of tasks, (4) preset one or more alerts, for reminding the user of futuristic tasks to be performed by him. For example, an alert can be programmed by the user which reminds him to take a medicine at a prescribed time. According to another example, the controller can be configured by the user to operate as an alarm clock, and (5) memorize telephone numbers in the form of a list, and modifying the list as desired by said user.

The user input means should include whatever components are needed to the user to operate the controller, depending on his capabilities and/or limitations, for instance, it may include a specially designed single button switch, or touch screen or voice recognition module, for implementing voice instructions. It may also include means for transmitting user's instructions directly to appliances to be controlled.

It should be understood that whenever in this description and claims reference is made to “introducing an appliance, or appliances”, this means that there are displayed graphic icons/symbols, in the case of optical displays (e.g., a screen), or, alternatively, the user can associate desired spoken word(s) to each icon, simply by saving his own voice or by using text to speech module, as opposed to conventional solutions which make use of hard coded voice or sounds which usually are not descriptive enough.

Means for recognizing a sub-environment and for identifying a specific appliance are known in the art. With respect to recognition of a sub-environment, a location signal may be, preferably, sent by an emitter, Tag or beacon to a corresponding receiver, wherein the receiver is operatively connected or built, or incorporated, into the controller. The location signal is a wireless signal. It could be, for instance, a radio (RF) or Infrared (IR) signal. The signal, of whatever kind, may be transmitted only when the user moves (using motion detector), or it may be transmitted repeatedly, or it maybe requested intermittently by the controller, by sending an inquiry signal, and transmitted upon such request.

The inquiry signal, forwarded by the controller and intended to be received at the corresponding beacon, or Tag, can be automatically and repeatedly emitted from the controller, though this is not necessarily so, as the emission of an inquiry signal can be effected by an interaction between the user of the controller and the controller. However, the first option (i.e., the automatic option) is preferable because it does not involve performing an unnecessary interaction between the user and the remote controller.

The means for the user to select, the specific appliance or appliances which he wishes to control, may be by themselves conventional. If the display is comprehensive and on a screen, the user can select the specific appliances by touch, or by any other means known in the art. If the display is a queue display, the user can stop the display when the desired appliance appears, or, if the appliances appear by sub-groups, he can stop the display when the sub-group including the desired appliance appears, and then select the desired appliance by the same means applicable to a comprehensive display. If the display is acoustic, the user can stop it in a similar way, or might issue an oral command, using transducer means being provided to change said oral command to a digital one. Such oral command may be a simple and user friendly selection and approval means. Since the same selected appliance can be represented by several names, it is preferable to select the required appliance from an interface or a menu by inputting an oral command that approves or denies the selection. However, any other selection, means may be used, as well.

Once the user has chosen the desired appliance or appliances, he will control it or them by means that are available in the art and could be for instance those described in the references cited hereinbefore. It will be apparent that each appliance has an inner interface for implementing, or responding to, commands. In the system of the invention, those commands may be generated by the user, for instance, by means of a single switch or a touch screen, and may be transmitted to the inner control of the appliance by means well known in the art, or may be generated and/or transmitted by the user input means. Anyway, any appliance control means may be used within the scope of the invention.

According to one preferred embodiment of the invention, one or more of the appliances is connected to the power line via an “X10” adapter, via which the one or more appliances can be controlled by the controller of this invention. According to this embodiment, the controller is programmed to communicate with a corresponding “IR-to-X10” interface, which is electrically connected to the same power line, to forward thereby, and via the power line and “X10” adapters, the control commands to the respective appliance. The operating principles of the “IR-to-X10” interface and the X10” adapters will not be described herein, as these principles are known to those skilled in the art. Such interface and adapter are manufactured by, e.g., Marmitek. IR-driven appliances may be controlled directly by the controller. Alternatively, an IR-RF-IR Remote-control extender or a Blue-Tooth/Wi-Fi-IR distributor may be used.

The method for remotely controlling a plurality of appliances, by a user and through the controller, that are located in different sub-environments (which are represented by corresponding icons that are displayed on a first section of the display of the controller) of a specific environment, comprises a first step in which the controller recognizes the specific sub-environment in which it is currently located (hereinafter ‘the recognized sub-environment), and a second step in which the controller responds to the sub-environment recognition step by automatically displaying to the user, on a second section of the display of the controller, and in a queue arrangement, an iconic representation of only the appliances that reside in the recognized sub-environment, and which the remote controller is setup to control. For example, if the sub-environment is a living room in a house (the ‘house’ being the environment in this example), the controller will first ‘recognize’ that it is currently in the living room (the recognized room, or recognized sub-environment), and, then, it will respond by automatically displaying to the user only the controllable appliances residing in the living room (e.g., TV set, Stereo set, electrical Lamp, etc.), and by doing so, it actually automatically ‘selects’the living room from among the other rooms (i.e., among the other sub-environments) of the house, to allow the user to control its appliances. Although the controller of this invention is intended to select the sub-environment in automatic manner, the controller is also equipped with means to allow its user to indicate to the controller (by user input means) which one of the sub-environments he selects, after which the controller will respond by automatically introducing to the user only the menu relevant to the (now manually) selected sub-environment.

Accordingly, the method for allowing a user, by use of a remote controller, to control the operation of appliances in an environment, which are distributed among sub-environments, the control being location (i.e., sub-environment) dependent, comprises:
a) a first step, according to which the controller recognizes a sub-environment in which it is currently located; and
b) a second step, according to which the controller introduces to the user, for control, only an appliance, or a group of appliances, that is/are located in the recognized sub-environment.

According to the invention, there are three main options for a user to interact with the remote controller: (1) ‘Normal interaction’; (2) ‘Full acoustic interaction’; and (3) ‘Half-acoustic interaction’.

By ‘normal interaction’ is meant that the remote controller displays to a user, on a touch screen, options, menus and appliances, and the user responds to an option, offered to him by the controller, by displaying it to the user, by simply touching, essentially everywhere, on the screen. In case where the screen is not of the ‘touch-screen’ type or whenever the user expect problems while operating a touch screen, the remote controller can be equipped with a user input means which the user can use to select desired options. This kind of interaction is known in the art as “one button switch”.

According to this option, the user operates the controller, either by touching a touch screen (when such a screen is available), or by using a GUI, to select an iconic representation of one of the appliances which he desires to control (e.g., the TV set). In response to his selection, the remote controller displays to the user the iconic representation of the appliances such that the selected appliance is moved to a predetermined position (i.e., if it is not already in this position) in the queue arrangement relative to the remaining iconic representations. The iconic representation of the selected appliance after being ‘moved’ to the predetermined position is hereinafter referred to as ‘outstanding appliance’. The outstanding appliance may, additionally or alternatively, be given an appearance distinct from the appearance of the remaining (i.e., non-selected) iconic representations within the queue arrangement. Concurrently with making a selected appliance outstanding, control options (e.g., “VOLUME +”, “VOLUME−”, “NEXT TV CHANNEL”, “PREVIOUS TV CHANNEL”, etc.) are displayed to the user on a third section of the display of the remote controller, by which the user controls the operation of the outstanding appliance.

By ‘full acoustic interaction’ is meant that the controller is configured to acoustically specify to a user the recognized room and concurrently, in a queue manner, the controllable appliances located in this room. The remote controller is also configured to respond to oral commands of the user. For example, after acoustically specifying to the user that he is in a specific room, and that that room contains, e.g., a TV set, the user can orally command the controller to activate the TV set, after which the controller can acoustically indicate to the user that the TV set is “ON”. Then, if so desired, the user can orally command the controller to select a channel (if not already tuned to that channel), raise or lower the sound of the TV set, etc. The ‘full acoustic interaction’ option is beneficial in particular to users who are blind or to users who have vision problems. According to this option, iconic representation of the menus/appliances is only an option. Oral commands may be more accurately used by approval/denial of options proposed to the user (e.g., by “Yes” or “No” oral utterances).

By ‘half-acoustic interaction’ is meant, according to one variant, that the controller displays to the user to select, in a queue manner, sub-environments, or, if a sub-environment has already been selected, it displays to the user to select, in a queue manner, appliances, and the user responds by orally indicating to the controller his selection of one of the options. According to a second variant, the controller acoustically indicates to the user selectable options and the user responds by pressing the touch screen of the controller to confirm a selection of a desired option.

The first variant of the ‘half-acoustic interaction’ option is beneficial in particular to users who cannot use their hands or fingers to operate the controller, but can clearly see the icons, or other graphical representation, displayed to them by the controller. According to this option, a ‘simple’ screen (i.e., non-touchable screen) may be used, to display the iconic representation of the menus/appliances. The second variant of the ‘half-acoustic interaction’ option, as well as the ‘full acoustic interaction’option, are useful in cases where the users are blind or they have a poor sight capability.

According to the invention, the communication between the reader and a specific Tag occurs whenever the distance between the reader and the specific appliance is less than some dynamic threshold value, which can be varied by the software that is included in the reader. Having this condition fulfilled, the remote controller will obtain the unique code from the reader and respond to it by introducing to the user the icon relating to the ‘selected’ (i.e., identified) appliance, as well as the icons relating to the control options pertaining to the identified appliance. However, from that point on, in order to actually control the identified appliance, the user will have to interact with the controller according to any of the ways that are described herein.

In one preferred embodiment of this invention, the controller of this invention is also configured to predict futuristic tasks and respond to the prediction as described hereinafter. The prediction is based on the statistical analysis of the ‘time and location stamped’ historic preferences of the user. In other words, the controller is configured to analyze historic preferences, or selections, of the user, while considering the time and locations, at which they occurred in the past, and to introduce to the user, whether visually or acoustically, control options, which have been statistically found by the controller to be most preferable at the given time in the future. By ‘task’ is meant, therefore, a schedule, or a list of appliances, which the controller predicts, or expects, that the user might select them at the destined time and location.

Preferably, the appliances are introduced to the user by performing the steps of: a) displaying to the user in a circular queue arrangement, or in a ring like manner, iconic representations of the appliances which the remote control is setup to control; b) accepting input from the user indicating one of said appliances which the user desires to control; and c) displaying the iconic representation of said appliances such that the iconic representation of said appliance indicated by the user is moved to a predetermined position in the circular queue arrangement relative to the remaining iconic representation and is given an appearance distinct from the appearance of the remaining iconic representations within the circular queue arrangement to thereby indicate to the user the current operational mode of the universal remote control.

The invention is also directed to a remote control extender, for extending the control range of the operation of appliances without introducing line of sight limitations, which comprises:
a) a wireless transceiver for communicating with a user interaction means, for allowing the user to activate control options in the appliances;
b) an integrated circuit that consisting of:
   a memory, in which IR codes, required for activating the control options, are stored;
   a processor, for receiving control data being the selected appliance and associated functionality, for associating the control data with the desired IR code, and for forwarding the desired IR code to an IR transmitter; and
   an IR transmitter, connected to the processor, for transmitting the desired IR code to the selected appliance.

The remote control extender may have a unique ID that can be identified by the user interaction means, for allowing the user interaction means to selectively communicate with the remote control extender.

### BRIEF DESCRIPTION OF THE DRAWINGS

In the drawings:

FIG. 1 is a schematic plan view illustrating a layout of an exemplary environment, in accordance with the invention;

FIG. 2 is a schematic front view of a remote controller according to an embodiment of the invention;

FIG. 3 is a schematic block diagram of a remote controller, according to one preferred embodiment of the invention;

FIG. 4 schematically illustrates an exemplary IR-based sub-environment recognition device (beacon), which is based on motion detector;

FIG. 5 schematically illustrates an exemplary RFID device, which is used in this example to identify an appliance to the controller whenever closed to one another, according to a preferred embodiment of the present invention; and

FIG. 6 schematically illustrates a remote control with an extender, according to a preferred embodiment of the invention.

### DETAILED DESCRIPTION OF PREFERRED EMBODIMENTS

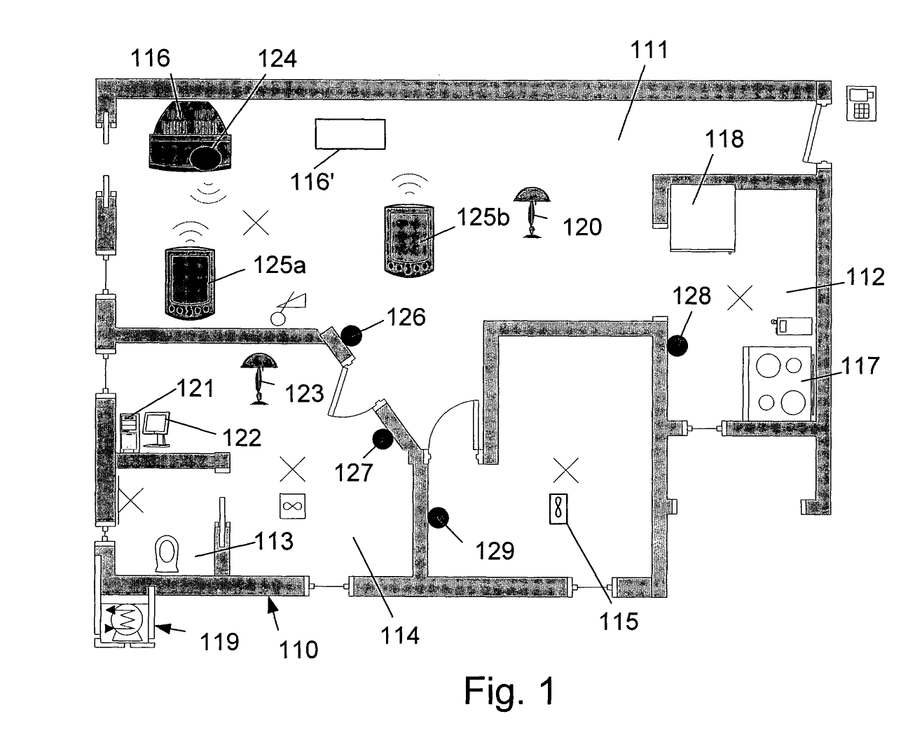

FIG. 1 schematically illustrates an embodiment of the system of the present invention, wherein the user lives and moves in an exemplary flat illustrated at 110 in schematic plan view. Flat 110, being an exemplary environment includes: living room 111, kitchen 112, toilet room 113 and study room 114. Reference numeral 115 denotes a spare room which is empty at the moment and does not contain controllable appliances.

Living room 111 includes, according to this example, a TV set (116), a DVD (116′) and a lamp 120. Kitchen 112 includes gas stove 117 and dish washing machine 118. Toilet room 113 includes a boiler 119, and study room 114 includes computer 121, computer's monitor 122 and lamp 123. All of the aforesaid appliances are configured to be wirelessly controlled by remote controller 125. Controller 125 is shown in two positions, one position (125a) being directly in front of and close to TV set 116 and the other (125b) being any other position in living room 111.

Each of the rooms (being sub-environment units of environment 110) includes an electronic beacon (herein sometimes just ‘beacon’ or ‘emitter’) for transmitting to remote controller 125 a signal recognizing the room (i.e., sub-environment) in which the emitter is installed. In this example, living room 111 is equipped with beacon 126, study room 114 with beacon 127, kitchen 112 with beacon 128 and empty room 115 with beacon 129. Each beacon is configured to wirelessly transmit a location signal to controller 125 to allow it recognizing the room (‘sub-environment’) in which it resides. Beacon 126 transmits a location signal which carries a code unique to living room 111, beacon 127 transmits a location signal which carries a code unique to room 114 and so on, to allow the controller 125 to distinct between the different rooms, or sub-environments.

Each beacon can be based, for example, on a motion detector. Accordingly, when the user of controller 125 enters a specific room, for example he enters living room 111, the related beacon (pursuant to this example—beacon 126) detects this entrance, after which beacon 126 transmits the code unique to living room 111, whereby to allow controller 125 to recognize that it is currently in living room 111. Controller 125 will, then, respond to the recognition of the living room by introducing to the user a menu relevant only to the recognized room. In the latter example, it will introduce to the user only the appliances residing in the living room 111 (i.e., appliances 116, 116, and 120).

Proximity sensor 124 is an electronic Tag (or beacon) that is located on TV set 116, or it can, alternatively, be incorporated into TV set 116, to wirelessly forward to the controller 125 an identification signal that indicates to the controller 125 that it is located near TV set 116. This way, when controller 125 senses that it is in the vicinity of a specific appliance (TV set, in this example, position 125a), it assumes that the user of the desires to operate TV set 116, and will act accordingly, namely, it will automatically introduce to the user only the options relevant to the operation of the TV set 116. The introduction of the options to the user can be either by displaying the options, or by use of verbal means, or both. Of course, each one of the appliances can be assigned a similar proximity sensor.

Each one of the electronic Tags (only one is shown in the example shown in FIG. 1, that is Tag 124) is configured to transmit an identification signal, for identifying the related appliance, to be received by controller 125 only if it is within some predefined ‘seeking’ range from the appliance. The predefined seeking range is initially user-configured to some desired range, after which it (i.e., the predefined range) automatically and dynamically changes (i.e., by the controller's software) in accordance with the inputs feedback from the user (i.e., user selections of appliances and control options). More specifically, the controller starts ‘seeking’ for an appliance that is located within a relatively large initial range from the controller, and if the controller identifies an appliance located at the maximum distance of this range but the user decided not to operate the identified appliance more than a predetermined number of occasions (such as by inputting a ‘denial’ command to the controller), the controller ‘assumes’ that the user has changed his preferences and will respond by automatically shortening the seeking range, such that an appliance will be identified by the controller, and be offered to the user to operate, only if the controller is at a distance from the appliance that is shorter than the initial seeking range.

Controller 125 can be provided with means, such as an RFID reader, for receiving the identification signals and to extract therefrom the corresponding location codes.

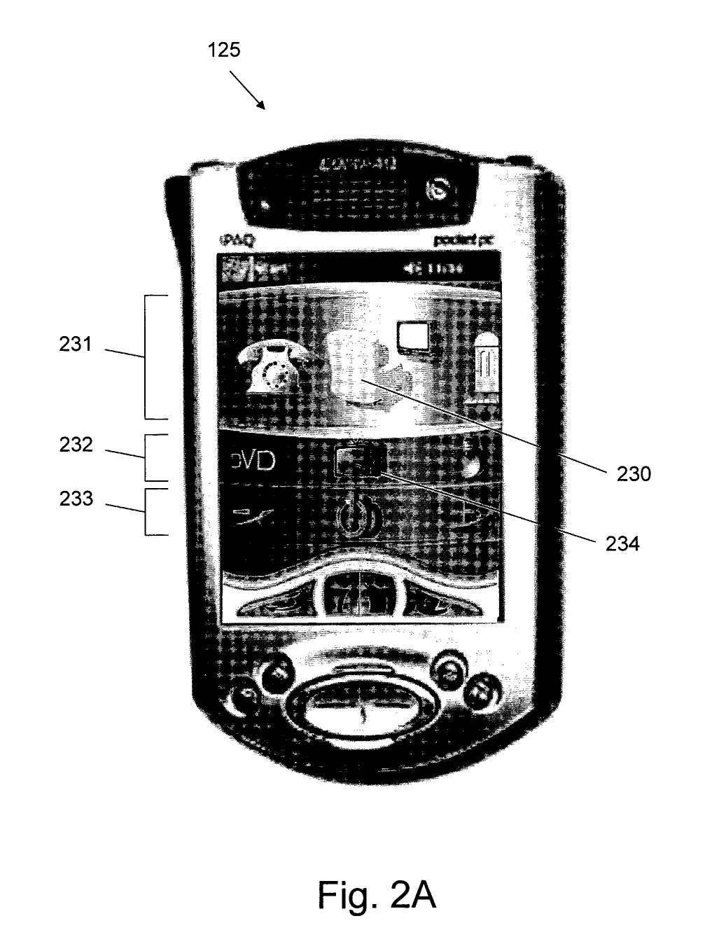

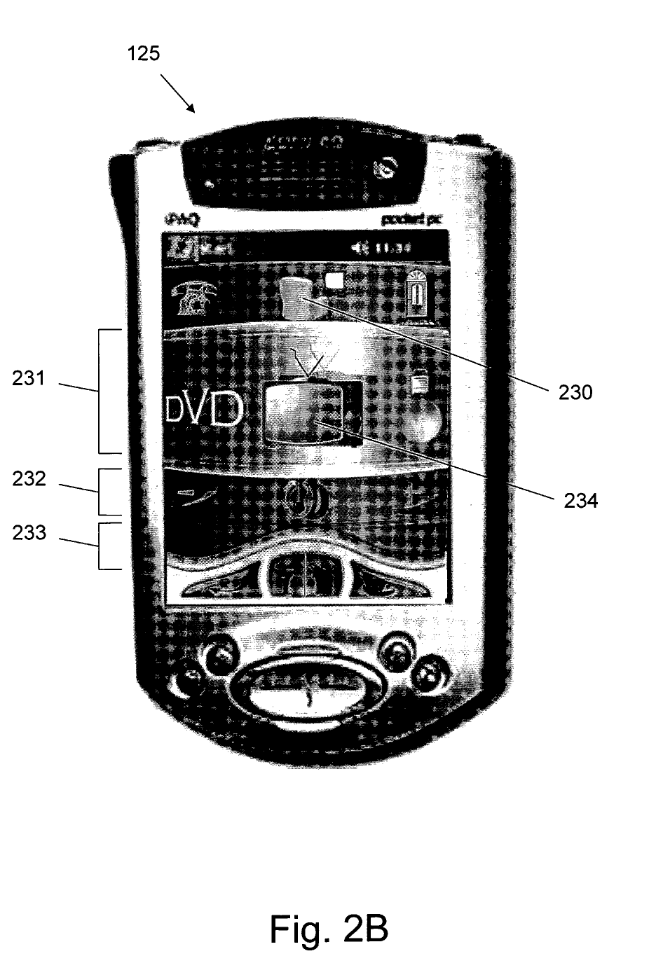

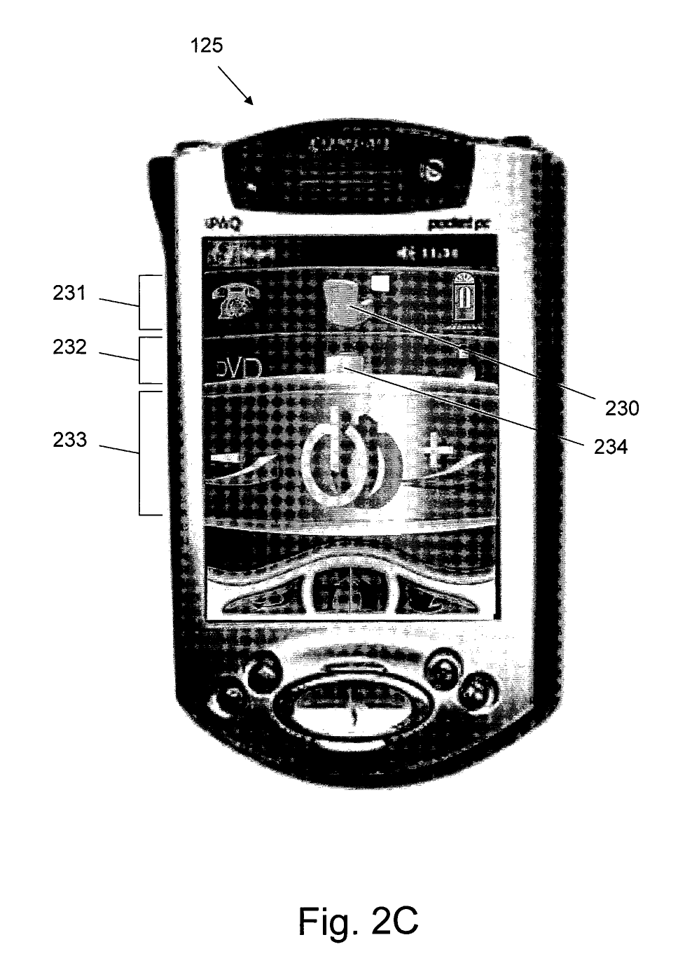

An exemplary touch screen display of remote controller 125 is shown in FIG. 2. The touch screen display which comprises several sections. In section 231 are displayed the iconic/symbolic representations of the different sub-environments. Once the controller 125 has received a location signal relating to particular recognized sub-environment; i.e., the relevant sub-environment, (e.g., a room, in this example), the icons in section 231 rearrange themselves so as to indicate the recognized sub-environment to the user, by making the icon of the recognized sub-environment (i.e., the relevant icon/symbol) graphically (and/or, depending on the application, acoustically) outstanding, or distinctable, with respect to the other icons. This can be done in many suitable graphic ways. For example, the relevant symbol/icon may be moved to the center of section 231, or it may be enlarged or be more brilliant.

Referring to the example shown in FIGS. 2A, 2B and 2C, living room 111 (see FIG. 1) has been recognized by controller 125 (125a in FIG. 1) as the current, or relevant, sub-environment. Therefore, icon 230, which represents living room 111 has been moved to the center of section 231, and, in addition, section 231 has been ‘enlarged’, or ‘expanded’, (FIG. 2A), with respect to some basic size, indicating, thereby, to the user (not shown) that the controller, and therefore the user, is currently in living room 111, and offering him an option to select living room 111 by ‘tapping’ anywhere on the touch screen display, or, depending on the application, to press the touch screen on the related icon (icon 230). If the user selects living room 111, section 231 resumes its original, smaller, size, and section 232, which displays icons of appliances relating to the (currently selected) living room 111, is enlarged (see FIG. 2B), to indicate to the user possible appliances (e.g., DVD, TV set, lamp, etc) that the user might desire to control. Referring to FIG. 2B, because controller 125 identified (i.e., according to the example and by using any of the ways described herein) TV set 116 (FIG. 1) as being close enough to it, controller 125 assumes that the user desires to operate TV set 116. Accordingly, icon 234, which, according to the example, represents TV set 116, is shown in the middle of section 232 and its appearance is made outstanding (i.e., larger) with respect to the other icons in section 232, whereby to offer it to the user to control.

Next, the user selects TV set 116, by employing any of the ways described hereinbefore, for example by touching an arbitrary point of the screen, and, in response, section 232 resumes its smaller, basic, size, whereas section 233 is enlarged, to offer to the user control options to control the currently selected appliance (i.e., TV set 116, represented by icon 234).

Additionally, or alternatively, the sections 231 and 232 can be enlarged, with respect to their basic size, automatically; that is, without any intervention from the user. In this case, section 231 will be automatically enlarged whenever the controller recognizes a sub-environment, and the section 232 will be enlarged whenever the controller identifies an appliance.

Different ways for selecting appliances to be controlled and for controlling them could, of course, be used. For example, the screen might not be a touch screen, but the controller can be provided with a different kind of user input means, which the user will employ for choosing and controlling the appliances. If the controller is not supplied with a user input means, the queue can be started and stopped by means of a single switch or by use of voice commands or in any other way that is provided by the art. Oral selection is another possible way of choosing and controlling the appliances. In the oral selection, the remote controller specifies acoustically to the user which is the relevant, or recognized, room and then, sequentially, the appliances contained within said room. The user then orally or manually advises the remote controller which appliance he selects and what commands he wishes to transmit to the selected appliance. Oral selection and control is beneficial in particular to users who are blind or have vision problems. Combined selection is another possible way of choosing and controlling the appliances, which is partly optic and partly acoustic. The remote controller displays to a user the relevant, recognized, room and, by iconic representation, the appliances contained therein, and the user responds by orally selecting the desired appliance and then orally enunciating the control commands. The combined selection is adapted in particular to users who cannot use their hands or fingers to operate the remote controller, but can see the displayed icons, or other graphical representation. For implementing such selection too, the remote controller must comprise a voice recognition module. The principles of voice recognition are known to those skilled in the art and, therefore, they are not described herein.

As has been said hereinbefore, one of the steps of the method of the invention is determining the current location (i.e., recognizing the current sub-environment) of the remote controller and, depending on the application, determining its proximity to a specific appliance, and offer to him only appliances and control options relating to the relevant location and/or proximity. In order to determine whether the controller is in the vicinity of a specific appliance, the remote controller, when activated, emits, for example, an inquiry signal or sequence of inquiry signals with variable lengths. If the inquiry signal is received by the proximity sensor, meaning that the user is in the predefined range with respect to the appliance relating to the proximity sensor, the proximity sensor transmits the appliance code to the controller so that the controller “knows” that the user is in the vicinity of the specific appliance and offers to the user control options for controlling this appliance. Such a system can be implemented using RFID technology (described in connection with FIG. 5) where the reader is incorporated into the remote controller, or externally communicates therewith, such as by use of Bluetooth technology, and small passive electronic tags (i.e., proximity sensors) are attached to the respective appliances. The problem of wall transparency which is undesirable here may be solved by shielding the electronic tag from behind, i.e., the side opposite what may be called, the “communication side” (“communication”—with the remote controller).

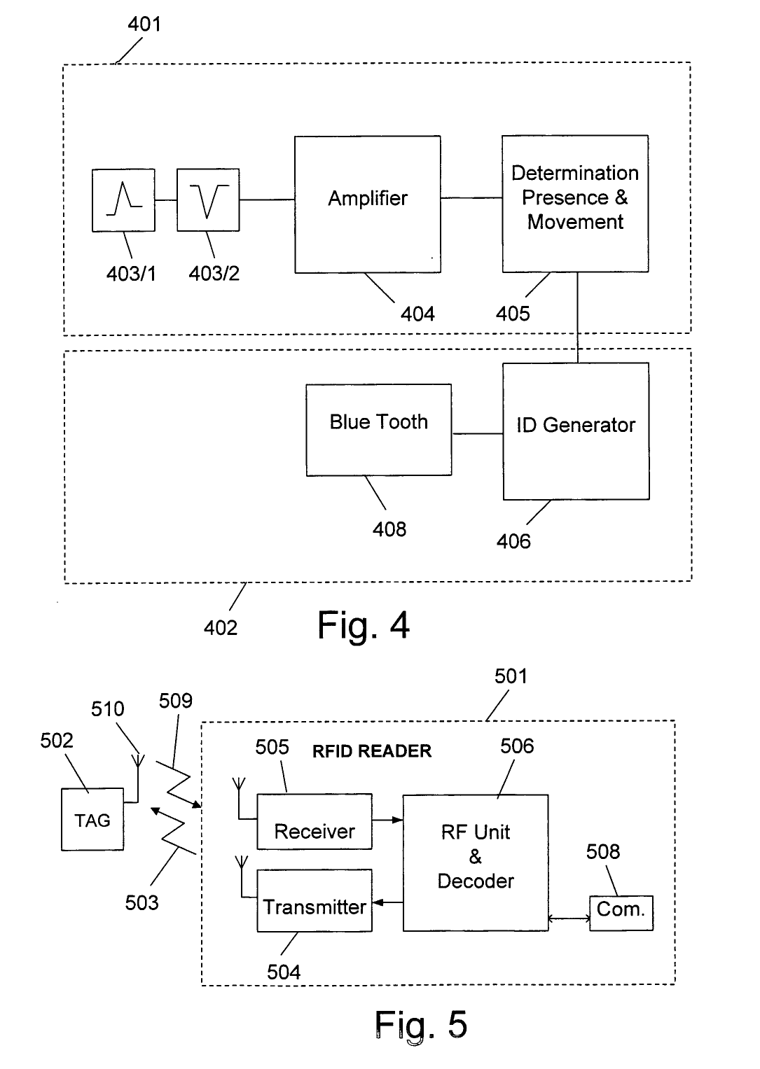

In order to determine whether the controller is currently in a specific sub-environment (e.g., in a specific room), the RFID technology can be used as well. Another method is described in connection with FIG. 4, where PYRO sensor is used to detect movements of the user. A beacon with the PYRO sensor can be installed, for example, in the entrance of each sub-environment and transmit sub-environment ID code to the remote control when the user enters.

The user may wish to control appliances in a room different from the one in which he is at a particular moment. The user may chose the room he wishes from the display of rooms (section 231, FIG. 2), and thereafter operate as described hereinbefore. This is permitted by using IR-to-RF and RF-to-IR modules, which convert infrared (IR) signals to corresponding RF signals, and RF signals back to IR signals. Using the RF intermediator signal allows bypassing, or overcoming, obstacles, such as the walls separating the sub-environments from one another. Alternatively, a Blue-Tooth/Wi-Fi-IR distributor may be used.

According to a preferred embodiment of this invention, the remote controller is configured to ‘learn’ the user's preferences, with respect to appliances and their control, by storing statistical data (in, e.g., a corresponding Log file) that relates to previous tasks performed by the user, and by analyzing this data. Then, the controller calculates, on the basis of the analysis of this data, a probability distribution of possible futuristic user's actions, to determine thereby which possible user's action is most likely to occur (or not ) at a given futuristic time. Accordingly, the controller offers to the user a next (expected) action, or actions, whose probability value(s) is/are first higher than a predetermined initial threshold value, and thereafter, the controller offers to the user a next (expected) action, or actions, whose probability value(s) are higher than an updatable threshold value that is dynamically updated by the controller according to accumulated user responses, whether manually and/or orally, to various options offered to him by the controller.

The calculation of the probability distribution relating to possible next user's actions is performed by the controller while considering the following data, which is stored in a Log file in the controller:
1) Periodicity of the different tasks/selections performed/made by the user;
2) Sequential order of the tasks/selections;
3) Multitasking, which refers to tasks that are expected to occur concurrently or after another such that there is only a small time gap between each two succes tasks;
4) Tasks durations; and
5) False activations.

The data in the Log file is analyzed by corresponding software, and if some habitual preferences of the user are identified by the controller, the controller automatically introduces to the user the options relevant to his preference(s), skipping unnecessary scanning, or queuing, through irrelevant options. For example, the controller may conclude (by analyzing the data stored in the Log file) that the user habitually switches on the TV set 116 (FIG. 1) in his living room each day shortly before eight o'clock (20:00) to watch his favorite news channel. Accordingly, if on the next day the user will be close enough to TV-set 116 shortly before, or around 20:00, the controller will automatically offer (by popping up on the display the option to activate the TV set on the expected channel, or by announcing this option) to the user to turn on the TV set on the expected channel. Of course, the user may choose any other option, as desired by him.

Referring again to FIG. 2, it shows an exemplary GUI according to a preferred embodiment of the present invention. The GUI provides very clear and convenient 3D representation of the sub-environments and of the control options, to make it user friendly and very intuitive to understand and operate. Two modes of operations are offered by the remote controller 125 to its users: (1) The touch mode, for users who are able to operate the controller by tapping on the touch screen, and (2) the auto-scanning mode, for physically disabled users.

A description will be given hereinbelow with respect to the two modes of operation:

(1) The touch mode

The first, second and third sections of the display of controller 125 (231, 232 and 233, respectively) are to be regarded as a 3D image of a virtual cylindrical surface, on which various sub-environments, appliances and control options appear.

The sections 231, 232 and 233 can be regarded as a first, second and third rings, respectively, which can be, so called ‘rotated’, independently of one another, which means that the icons, or symbols, move from one side of the screen to the opposite side, in a cyclic manner, so as to make an impression of rotation around an axis of rotation. For example, the aforesaid rotation can be done by timely tapping on the most right icon (for rotation to the right ) or most left icon (for rotation to the left) of each section 231, 232 and 233 (FIG. 2).

Section 231 contains iconic representation of the sub-environments, for example the icon 230 may represent the living room 111 shown in FIG. 1. The middle section (232) contains the iconic representation of the appliances, for example icon 234 may represent the TV set 116 shown in FIG. 1, and the lower section 233 contains the control options of the relevant appliance (pursuant to the example, the TV set 234). The number of the appliances simultaneously appearing on the screen will be dictated by the user ability to recognize and tap on the desired appliance. If there is not enough space in the screen for all the appliances, the user can easily reach the rest of the appliances by simply rotating the corresponding section.

If a particular sub-environment is automatically recognized by use of the corresponding electronic beacon, and a particular appliance is automatically selected by use of the corresponding electronic Tag, the first two sections (231 and 232) will be arranged automatically.

The Graphical User Interface (GUI) works as follow: after a selection of sub-environment is completed, whether manually (i.e., by tapping on the relevant icon on the upper section 231) or automatically, the middle section 232 is automatically ‘rotated’ to present to the user the relevant appliances. If required, the tapped sections will downscale (i.e., ‘shrink’) to provide more space for the other sections. Tapping on the icon of the desired appliance will cause it to change its state from “on” state to “off” state, or vice versa, if this appliance belongs to the “on”/“off” group. That is, an appliance belongs to this group if there is no control options other than the “on”/“off”, which relate to this appliance.

On tapping on multifunctional device (i.e., a device having control options other than “no”/“off”) the remote control panel of the taped appliance will appear on the lower section, providing the user with all the necessary control functions relating to the selected appliance. For example, on tapping on telephone icon the controller will provide the user with a phone book, the subsequent tapping on desired phone contact the controller will make a phone call. In addition, every screen will contain Favorites & Macros, Configuration and Alerts links.

(2) The Automatic Scanning Mode

This mode will be mainly used by physically disabled users that have difficulty to locate the desired spot on the screen and press on it. For this kind of users, the system will scan trough the options by rotating one or more sections, and/or by announcing an optional sub-environment, appliance, or control function of an appliance. In order to activate currently available option the user will have to touch the screen at any place, or pressing a remote button that is functionally connected to the controller).

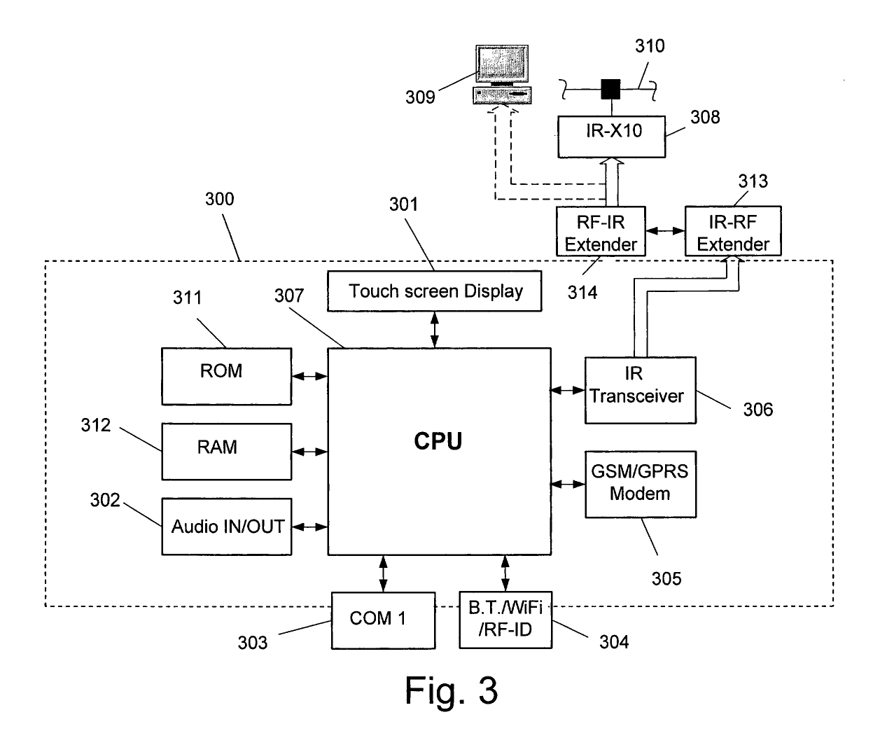

FIG. 3 is a block diagram showing the main components of the controller, according to a preferred embodiment of the present invention. Touch screen 301 is an optional Input/Output means, which allows an interaction between the controller and its user. As said before, according to one aspect of the invention, touch screen 301 displays to the user relevant menus, which, as said hereinbefore, are location (i.e., sub-environment) dependent. Touch screen 301 also allows the user to input a signal to the controller, to indicate to the controller that he accepts, or confirms or acknowledges the option that is currently displayed to him. The touch screen may function as a “one switch button”, meaning that whenever an option is currently offered to the user by the controller, the user may choose the offered option by pressing the touch screen irrespective of the location of the icon, or symbol, that represents the offered option. Likewise, “Audio IN/OUT” (302) allows oral/verbal interaction between the controller and its user as well as phone conversations.

Connection port “COM 1” (303) allows to connect to the controller a “single switch”, for allowing a disabled person to confirm/acknowledge to the controller an option which is offered to him, either visually, by means of touch screen 301, or acoustically, by means of audio IN/OUT 302. A single switch mechanism can be, for example, a “puffing” machine, which is a machine that converts pressure, caused by exhales of a person, to corresponding electric signal, which indicates to the controller 300 that the person approves the activation of the option currently offered to him.

Communication interface 304 allows controller 300 to obtain recognition and identification data from an external source. Preferably, controller 300 obtains the data in a wireless manner, though this is not necessarily so. Of course, communication means 304 can be utilized, mutatis mutandis, to implement any desired communication method (i.e., wireless or non-wireless), as the communication principles, which are required to fulfill the goals of the present invention, are known to those skilled in the art. The external source can be, for example, an RFID reader, such as the RFID reader 501 shown in FIG. 5, which is equipped with a communication means 508 capable of communicating with communication means 304. The functionality of reader 501 is described in detail in connection with FIG. 5. Communication interface 304 can be, for example, a Bluetooth interface that is configured to communicate with a corresponding Bluetooth beacon (508) to identify a user that enters a room. A Bluetooth device may function as a proximity sensor, to obtain, thereby, a signal indicative of, or which identifies to the controller 300, an appliance to which the reader 501 and thus the controller 300 is close enough, for offering to the user of controller 300, in response to the indicative signal, control options that pertain only to this (i.e., to the identified) appliance having the closest Tag. In this case, the closest appliance will generate an indication, such as a pop-up message that offers the user to select that appliance (it is assumed that the user will move closer to the appliance that he wishes to activate first). Alternatively, the RFID reader can be plugged-in into, or engaged with, a corresponding slot in controller 300. An example for such a ‘plugged-in’ RFID reader is the “i-card”, which is manufactured by “Identec Solutions” (Kelowna, British Columbia, Canada).

GSM/GPRS modem 305 is a wireless modem, which allows controller 300 to function as a cellular phone. ‘GSM’ stands for ‘Global System for Mobile communication’, and ‘GPRS’ stands for General Packet Radio Services, which is a packet-based wireless communication service that promises data rates from 56 up to 114 Kbps and continuous connection to the Internet for mobile phone and computer users. The higher data rates will allow users to take part in video conferences and interact with multimedia Web sites and similar applications using mobile handheld devices as well as notebook computers. GPRS is based on Global System for Mobile (GSM) communication and complements existing services such circuit-switched cellular phone connections and the Short Message Service (SMS). Accordingly, GSM/GPRS modem 305 allows the user of controller 300 to carry out wireless telephone calls and to brows the Internet.

The IR Transceiver 306 is also configured to transmit coded command signals to appliances which the controller 300 is set to control. Coded command signals can be forwarded from IR transceiver 306 directly to the controlled appliance (e.g., TV set 309), by means of an IR-X10 interface, which receives the IR (Infrared) coded signals from IR transceiver 306, translates them to corresponding“X10” format, and forwards the formatted codes, via the power line 310, to the corresponding appliance, which must be, in this case, connected to the same power line via a corresponding “X10” adapter. The IR Transceiver 306 can also be configured to learn IR codes from the remotes of the appliances, and replay the above codes on user demand, thereby making the controller virtually compatible with all existing IR-driven appliances. The “X10” technology is known to those skilled in the art, and, therefore, no description thereof is given herein.

CPU 307 functions to control the operation of the rest of the modules/units in controller 300 and to make decisions as to habitual preferences of the user. Memories 311 and 312 function to store therein the software required for the functioning of CPU 307 and for storing therein data relating to historical preferences of the user, to be statistically analyzed, by CPU 307, to allow CPU 307 to make the decisions.

Alternatively, coded command signals can be forwarded from IR transceiver 306 indirectly, using an IR-RF-IR extender 313 to 314. An exemplary IR-RF-IR extender may be in the Octopus package is LF-Univ module marketed by Terk Technologies Corporation, (Commack, N.Y., U.S.A.). No. This extender consists of two modules: an IR receiver/RF transmitter 314, which is connected to the PDA; and an RF receiver/IR transmitter 313, which is connected to the IR appliances. Since most of the PDAs today have a build-in Bluetooth or Wi-Fi transceivers, the use of additional RF module in the system serves seems to be redundant. Moreover, all pairs of LF-Univ modules are tuned to the same frequency, and therefore cause crosstalk problems, especially for installations in institutional buildings.

The crosstalk problem is solved, according to a preferred embodiment of the invention, by utilizing Bluetooth/Wi-Fi extenders for IR transmission . Each module has a unique ID. IR codes can be modulated by Bluetooth/Wi-Fi module on the PDA platform by means of software. These IR signal is demodulated back to IR in the corresponding base unit and will be send to IR-driven appliances. In addition to eliminate the need for unnecessary RF extender, this solution is much more reliable and allows also for centralized control. For example, the appliances several or even all institutional housemates can be driven by a “master environment control system” operated by the staff. Another, solution is to avoid IR signal modulation on the PDA. This can be achieved by “moving” all IR-related tasks to the base unit, which is connected to the IR driven appliances. This Bluetooth enabled unit will receive a device code, along with an activation code from the PDA (via the Bluetooth transceiver) and transmit corresponding IR codes from a storage memory. Such controllers are well known and available in the market (for example in http://www. innotechsystems. com/sp4001a.pdf).

FIG. 4 is a diagram of an exemplary electronic beacon, which is based on a motion detection sensor, which detects movement of a user of the controller (including detecting the movement direction, and thereby it can determine whether the user is within a particular sub-environment) by sensing its body heat. According to the invention, each sub-environment can be assigned, for example, such a beacon, which functions to transmit a location signal with a code unique to the sub-environment, to allow the controller to recognize thereby sub-environments.

PIR detector 403 is a passive infrared sensor that is broadly used to detect the presence of a nearby person, and also movements of the person in front of it, by sensing the heat irradiated from the person. An exemplary commercial PIR detector is the PIR 325, which is manufacture by GLOLAB.

Whenever a person moves in front of first PIR sensor 403/1, in a distance which conforms to its sensitivity range, it issues a first signal having a first polarity. Similarly, the second PIR sensor 403/2 issues a second signal having a second polarity (e.g., opposite) Both PIR sensors energize the, amplifier 404, which outputs a signal to “Movement Determination” unit 405, as well as the direction of moving, which is determined by the order of appearance of the signals. If it is determined (by unit 405) that the signal is indicative of the presence of a person, ID Generator 406, is caused, by unit 405, to generate a coded signal, unique to this PIR sensor, and thus unique to the related sub-environment, and to emit the coded signal, preferably by the Bluetooth device 408 or by other RF means.

The coded signal, which is emitted by IR LEDs 408, is received by the IR transceiver 306 of controller 300 (FIG. 3), provided that controller 300 is located within a range and in a zone that permit it to receive the coded signal. Controller 300 will recognize the sub-environment, in which it currently is, according to the unique code.

FIG. 5 is a diagram of an exemplary means for identifying appliances to the controller 300 (FIG. 3). Tag 502 is a passive or semi-passive electronic tag (i.e., it does not contain a power source or contain a power sources with relatively long living time for powering memory cheap only) that contains a unique digital code for identification purposes. For example, in connection with the purposes of the present invention, the unique code of tag 502 can be related to a specific sub-environment and/or to a specific appliance, to allow their identification by controller 300. In order for causing Tag 502 to transmit its code, Tag 502 has to be excited by an external reader, such as reader 501.

Reference numeral 501 denotes a Radio Frequency Identification (RFID) Reader, which is configured, among other things, to receive from the communication interface 304 (FIG. 3) of controller 300 a command to initiate an identification session with Tag 502. As noted hereinbefore in connection with FIG. 3, the communication between RFID reader 501 and controller 300 (FIG. 3) can be: (1) wireless, in which case, communication interface 508 (FIG. 5) is a wireless transmission means, preferably a typical Bluetooth transceiver module, and (2) non-wireless, in which case RFID reader 501 is ‘plugged’ into, or electrically engaged to, controller 300 by physically and electrically engaging communication interface 508 with communication interface 304 of controller 300. The RFID technology (including the reader 501 and tag 502) is known to those skilled in the art. However, a short description thereof is given hereinafter. The identification session between the reader 501 and the tag 502 includes: (1) transmitting an excitation signal to Tag 505, by transmitter 504 and via communication path 503, (2) receiving the coded excitation signal by the Tag 502, which (3) responds to the excitation signal by transmitting to the receiver 509, by antenna 510, a signal that carries a code that is unique to the Tag 502, and (4) identifying, thereby, Tag 502 by RFID reader 501.

“RF Unit and Decoder” 506 functions to handle the RF communication with Tag 502, and it can be programmed to cause transmitter 504 to transmit the excitation signal to any distance within its maximal transmission range. The latter feature can be utilized to ‘scan’ the area within the maximal transmission range to determine which Tags are located nearby the reader 501.

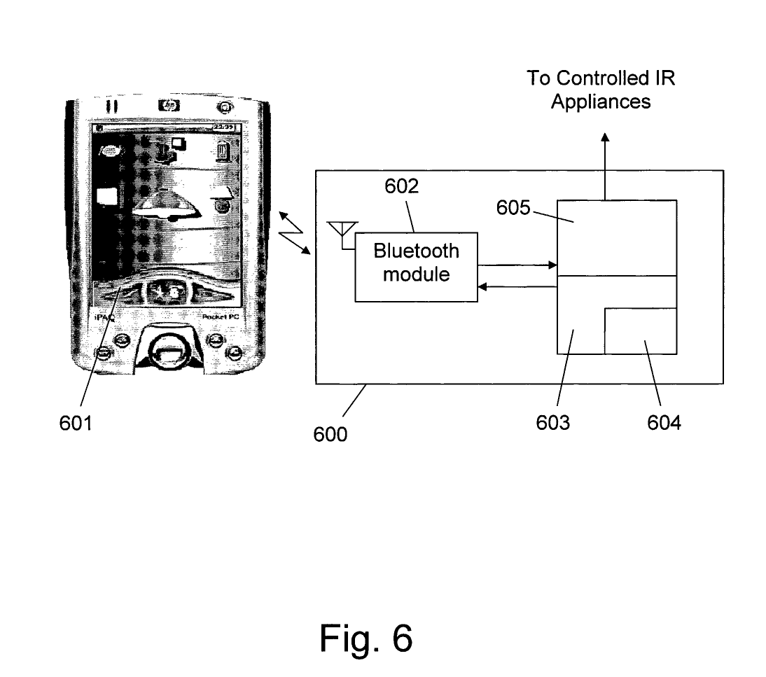

FIG. 6 schematically illustrates a remote control with an extender, according to a preferred embodiment of the invention. The remoter control comprises a PDA 601, which is the interface with the user. The PDA 601 has an integrated Bluetooth transceiver for communicating with other transceivers. A remote control extender 600, used for extending the control range of the operation of appliances located in different sub-environments and for eliminating line of sight limitations, is implemented on an integrated circuit. Extender 600 consists of a Bluetooth module 602, used for communicating with PDA 601 (through its integrated Bluetooth transceiver) and receives control data from PDA 601, regarding the appliance selected by the user and the associated functionality desired from the selected appliance. Extender 600 also includes a memory 604, that stores IR codes, required for activating the desired functionalities. A processor 603 receives the control data and associates the control data with the desired IR code that is stored in memory 604. Then processor 603 forwards the desired IR code to an IR transmitter 605, which transmits it to the selected appliance.

The above embodiments have been described by way of illustration only and it will be understood that the invention may be carried out with many variations, modifications and adaptations, without departing from its spirit or exceeding the scope of the claims.

1. System for allowing a user, by use of a remote controller, to control the operation of appliances located in different sub-environments of an environment, comprising:
a) a plurality of sub-environments' recognition means, each of which is allocated to a respective sub-environment and equipped with a code unique to said respective sub-environment; and
b) a remote controller, provided with means and configured to obtain from said recognition means location signal that contains said unique code to recognize thereby the sub-environment said controller is currently in, said controller introducing to said user, in response to the recognition of a sub-environment, control options relevant only to appliances located in the recognized sub-environment, said controller including user interaction means to allow said user to activate said control options as desired by him.

2. System according to claim 1, in which the location signal is obtained by detecting the presence of the user by the recognition means, said recognition means responding to the detection by transmitting said location signal to the controller.

3. System according to claim 1, in which the location signal is obtained by emitting an inquiry signal by the controller, which is intended to be received by a corresponding recognition means, and receiving said location signal from said recognition means in response to said inquiry signal.

4. System according to claim 1, further comprising, per desired appliance, appliance's identification means, the controller being provided with means for communicating with said identification means, for allowing the identification of said appliance by said controller whenever said controller is currently in the vicinity of said appliance, said controller introducing to the user to activate control options relating directly to the identified appliance.

5. System according to claim 1, in which the identification and recognition means comprise a set which includes an electronic Tag/beacon and a reader, essentially as described and illustrated and with particular reference to the examples.

6. (canceled)

7. System according to claim 1, further comprising “IR-to-RF” and “RF-to-IR” converters, for allowing the user to control appliances that are not necessarily in the same sub-environment as said controller.

8. System according to claim 1, in which the controller comprises:
a) communication means, as required for communication with the recognition and identification means for recognizing said sub-environments and appliances, respectively;
b) control means, including a processor, a memory and software for operating said processor;
c) an optical or acoustic, or both optical and acoustic, means for introducing to the user sub-environments, appliances and control options, and, in particular, appliances and their control options which relate to recognized sub-environments; and
d) interaction means for: (1) allowing said user to choose a particular sub-environment or a particular appliance, or appliances, that he wishes to control; and (2) for allowing said user to control the chosen appliance or appliances.

9. (canceled)

10. System according to claim 8, in which the optical means is a screen, or a touch screen, functionally divided into at least a first, second and third sections, said first section introducing to the user symbols that represent, or relate to, the sub-environments, said second section introducing to said user the appliances belonging to a currently recognized sub-environment, and said third section introducing to said user symbols representative of control options relating to an appliance chosen by said user, or to an identified appliance, said first, second and third sections having a basic size.

11. System according to claim 10, in which upon recognition of a specific sub-environment, said sub-environment is introduced to the user for selection by enlarging the first section, relative to its basic size, then by bringing the symbol, which represents said specific sub-environment, to the center of said first section, if not already there, and, finally, by making the appearance of said symbol outstanding with respect to the other symbols in said first section, and wherein upon selection of said sub-environment by said user, said first section resuming its basic size, whereas the second section is enlarged, relative to its basic size, to offer said user to select one of the appliances relating to said sub-environment, and wherein if a specific appliance, from among the appliances of said specific sub-environment, is identified by said controller, said specific appliance is introduced to the user for selection by bringing the symbol, which represents said specific appliance, to the center of said second section, if not already there, and, finally, by making the appearance of the symbol, relating to said specific appliance, outstanding with respect to the other symbols in said second section, and wherein upon selection, by said user, of the offered appliance, said second section resuming its basic size, whereas the thirst section is enlarged, relative to its basic size, to offer said user control options to control said specific appliance.

12. System according to claim 9, in which the controller is user-configurable, to allow said user to:
preset the controller with available appliances and sub-environments, and to relate each one of said appliances to a corresponding sub-environment;
relate voice files to one or more of the icons that represent sub-environments and/or appliances and/or operational functions, for allowing the controller to announce to the user current options and status of the controller;
program user defined macros, which relate to one or more sets of tasks, each of said macros being intended to be executed by said user using a single interaction with said controller, to perform the set of tasks related to the executed macro;
preset one or more alerts, for reminding the user of tasks to be performed by him, and, if desired, for operating said controller as an alarm clock; and
memorizing telephone numbers in the form of a list, and modifying the list as desired by said user.

13. (canceled)

14. (canceled)

15. System according to claim 11, in which the appliance or appliances groups are displayed optically by showing graphic symbols.

16. System according to claim 12, in which the appliances or appliance groups are displayed acoustically by sounding acoustic symbols.

17. (canceled)

18. System according to claim 4, in which the communication between the identification means and the controller occurs whenever said controller is within a predetermined range, which dynamically changes according to user input feedback being recorded in said controller.

19. Method for allowing a user, by use of a remote controller, to control the operation of appliances located in different sub-environments of an environment, comprising associating appliances to sub-environments and performing:
a) a first step, according to which said controller recognizes a sub-environment in which it is currently located; and
b) a second step, according to which said controller introduces to said user, for control, only the appliance, or a group of appliances, that is/are associated, or located, in the recognized sub-environment, and said user interact with said controller to control said appliance, or appliances.

20. (canceled)

21. Method according to claim 19, further comprising associating to desired appliances identification means, the controller being provided with means for communicating with said identification means, for allowing the identification of said appliances by said controller whenever said controller is currently in the vicinity of a specific appliance, said controller introducing to the user to activate control options relating directly to a currently identified appliance.

22. Method according to claim 21, wherein the communication between the identification means and the controller occurs whenever said identification means is within a predetermined range, which dynamically changes according to user input feedback being recorded in said controller.

23. Method according to claim 20, wherein the controller comprises optical means, being a screen or a touch screen display, which is functionally divided into at least a first, second and third sections, said first section introducing to the user symbols that represent, or relate, to the sub-environments, such that the symbol relating to a recognized sub-environment is made by the controller outstanding with respect to the symbols relating to the other sub-environments, said second section introducing to said user the appliances belonging to a currently recognized sub-environment, such that a symbol, representative of an identified appliance, is made by said controller outstanding with respect to symbols representative of the other appliances, and said third section introducing to said user symbols representative of the control options relating to the appliance chosen by said user, or to the identified appliance.

24. (canceled)

25. Method according to claim 19, wherein the controller recognizes a sub-environment by accepting from recognition means, with which said sub-environment is provided, a corresponding location signal.

26. Method according to claim 25, wherein the location signal is obtained by detecting the presence of the user by the recognition means, said recognition means responding to the detection by transmitting said location signal to the controller.

27. Method according to claim 25, wherein the location signal is obtained by emitting an inquiry signal by the controller, which is intended to be received by a corresponding recognition means, and receiving said location signal from said recognition means in response to said inquiry signal.

28. Method according to claim 19, wherein the identification and recognition means comprise a set which includes an electronic Tag and a reader, or a beacon, essentially as described and illustrated and with particular reference to the examples.

29. (canceled)

30. Method according to claim 19, further comprising allowing the user to control appliances that are not necessarily in the same sub-environment as said controller by use of “IR-to-RF” and “RF-to-IR” converters.

31. (canceled)

32. (canceled)

33. (canceled)

34. (canceled)

35. (canceled)

36. (canceled)

37. (canceled)

38. A remote control extender, for extending the control range of the operation of appliances without introducing line of sight limitations, comprising:
a) a wireless transceiver for communicating with a user interaction means, for allowing said user to activate control options in said appliances;
b) an integrated circuit, consisting of:
a memory, in which IR codes, required for activating said control options, are stored;
a processor, for receiving control data being the selected appliance and associated functionality, for associating said control data with the desired IR code, and for forwarding said desired IR code to an IR transmitter; and
an IR transmitter, connected to said processor, for transmitting said desired IR code to said selected appliance.

39. A remote control extender according to claim 38, having a unique ID that can be identified by the user interaction means, for allowing said user interaction means to selectively communicate with said remote control extender.
